(19) United States
(12) Patent Application Publication
(10) Pub. No.: US 2026/0003057 A1
(43) Pub. Date: Jan. 1, 2026

(54) METHOD FOR PERFORMING OBJECT DETECTION WITH AID OF MULTI-STAGE DETECTION CONTROL IN WIRELESS COMMUNICATION SYSTEM, AND ASSOCIATED APPARATUS

(71) Applicant: MEDIATEK INC., Hsinchu City (TW)

(72) Inventors: En-Chieh Hsia, Hsinchu City (TW); Tsung-Han Tsai, Hsinchu City (TW)

(73) Assignee: MEDIATEK INC, Hsinchu City (TW)

(21) Appl. No.: 19/250,124

(22) Filed: Jun. 26, 2025

Related U.S. Application Data
(60) Provisional application No. 63/665,234, filed on Jun. 27, 2024.

(51) Int. Cl. G01S 13/56; G01S 13/00; H04B 7/06

(52) U.S. Cl. CPC G01S 13/56; G01S 13/003; H04B 7/0626

(57) ABSTRACT

A method for performing object detection with aid of multi-stage detection control in a wireless communication system, performed by a first wireless communication device, and associated apparatus are provided. The method may include: receiving at least two packets from a second wireless communication device, obtaining at least two channel state information (or “the CSIs”) based on the packets, and performing a preliminary detection according to the CSIs to generate a preliminary detection result in a first stage, for indicating whether potential object is detected between the wireless communication devices; and in response to the preliminary detection result indicating that the potential object is detected, transmitting a radar signal, receiving a reflected radar signal of the radar signal, and performing a radar-based detection according to the radar signal and the reflected radar signal to generate a radar-based detection result in a second stage, for indicating whether the potential object is present.

### CROSS REFERENCE TO RELATED APPLICATIONS

This application claims the benefit of U.S. Provisional Application No. 63/665,234, filed on Jun. 27, 2024. The content of the application is incorporated herein by reference.

### BACKGROUND

The present invention is related to detection control, and more particularly, to a method for performing object detection with aid of multi-stage detection control in a wireless communication system, and associated apparatus such as a wireless communication device in the wireless communication system.

According to the related art, presence detection may be helpful on various kinds of automation applications such as smart home applications. For example, a wireless device in at least one wireless network such as a Wi-Fi network may be arranged to perform the presence detection according to channel state information (CSI), where the wireless device may be wirelessly linked to another device in the wireless network, for obtaining the CSI. Some problems may occur, however. The CSI may be retrieved from generic Wi-Fi signals, and may be affected by environmental interference, especially in the 2.4 gigahertz (GHz) band. In addition, it is typically hard to determine whether the presence, such as a person or thing that is present as detected via the presence detection, is close to the wireless device or the other device, and such detection cannot provide precise distance information. As the Wi-Fi signals are not designed especially for the presence detection, further improve a correct rate of the presence detection may be unachievable. The related art tries to correct the problems, but further problems such as some side effects may be introduced. Thus, a novel method and associated architecture are needed for solving the problems without introducing any side effect or in a way that is less likely to introduce a side effect.

### SUMMARY

It is an objective of the present invention to provide a method for performing object detection with aid of multi-stage detection control in a wireless communication system, and associated apparatus such as a wireless communication device in the wireless communication system, in order to solve the above-mentioned problems.

At least one embodiment of the present invention provides a method for performing object detection with aid of multi-stage detection control in a wireless communication system, performed by a first wireless communication device. For example, the method may comprise: receiving at least two packets from a second wireless communication device, obtaining at least two CSIs based on the at least two packets, and performing a preliminary detection according to the at least two CSIs to generate a preliminary detection result in a first stage, wherein the preliminary detection result at least indicates whether a potential object is detected between the first wireless communication device and the second wireless communication device; and in response to the preliminary detection result indicating that the potential object is detected, transmitting a radar signal, receiving a reflected radar signal of the radar signal, and performing a radar-based detection according to the radar signal and the reflected radar signal to generate a radar-based detection result in a second stage after the first stage, wherein the radar-based detection result at least indicates whether the potential object is present.

At least one embodiment of the present invention provides a wireless communication device, for performing object detection with aid of multi-stage detection control in a wireless communication system, where the wireless communication device is one of multiple devices within the wireless communication system such as that mentioned above. The wireless communication device may comprise a transceiver that is configured to receive at least two packets from a second wireless communication device. The wireless communication device may further comprise a processor that is coupled to the transceiver and configured to control operations of the wireless communication device. For example, the processor may be further configured to obtain at least two CSIs based on the at least two packets, and perform a preliminary detection according to the at least two CSIs to generate a preliminary detection result in a first stage, wherein the preliminary detection result at least indicates whether a potential object is detected between the wireless communication device and the second wireless communication device. In addition, the transceiver may be further configured to transmit a radar signal in response to the preliminary detection result indicating that the potential object is detected, and receive a reflected radar signal of the radar signal. Additionally, the processor may be further configured to perform a radar-based detection according to the radar signal and the reflected radar signal to generate a radar-based detection result in a second stage after the first stage, wherein the radar-based detection result at least indicates whether the potential object is present.

It is an advantage of the present invention that, through proper design, the method of the present invention, as well as the associated apparatus such as the wireless communication device, can increase the true presence rate (or “the hit rate”) to be as high as possible, without significantly increasing the total power consumption. For example, merely performing the radar-based detection without performing the preliminary detection in advance may need to send the radar signal periodically all the time, and therefore may lead to high power consumption. With the aid of the multi-stage detection control, the wireless communication device can perform the preliminary detection in advance for achieving a rough detection result while saving power by preventing radar transmission in a first stage, and perform the radar-based detection for achieving a precise detection result in a second stage, in order to enhance the overall performance. In addition, the method of the present invention and the associated apparatus such as the wireless communication device can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates a two-stage detection control scheme of a method for performing object detection with aid of multi-stage detection control in a wireless communication system according to an embodiment of the present invention.

FIG. 3 illustrates a CSI-based detection control scheme of the method according to an embodiment of the present invention.

FIG. 4 illustrates a radar-based detection control scheme of the method according to an embodiment of the present invention.

FIG. 5 illustrates some implementation details of the radar-based detection control scheme shown in FIG. 4 according to an embodiment of the present invention.

FIG. 6 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

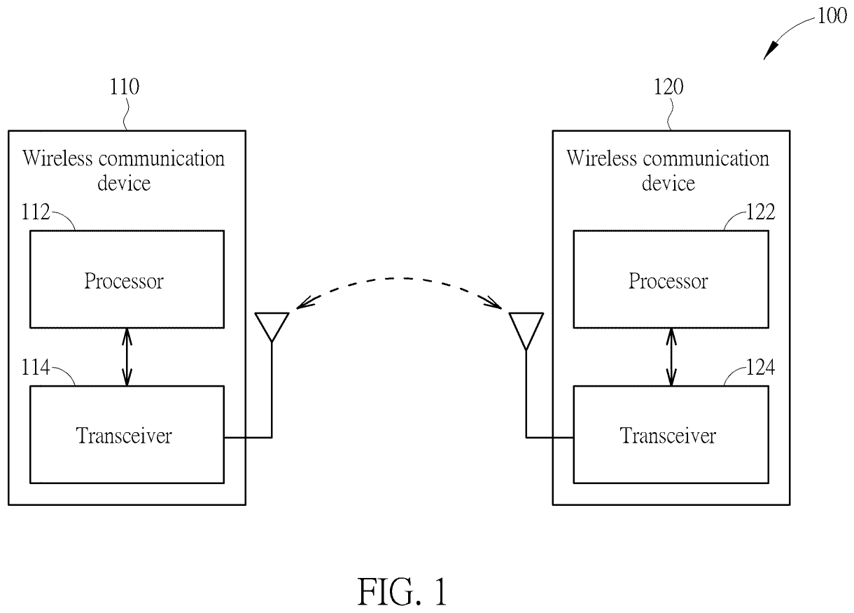

FIG. 1 is a diagram of a wireless communication system 100 according to an embodiment of the present invention. For better comprehension, the wireless communication system 100, as well as any wireless communication device #z among multiple wireless communication devices #1, . . . and #Z therein, may be compatible or backward-compatible to one or more versions of the Institute of Electrical and Electronics Engineers (IEEE) 802.11 standards, but the present invention is not limited thereto. Regarding the multiple wireless communication devices #1, . . . and #Z within the wireless communication system 100, a wireless communication device 110 may represent the wireless communication device #1, a wireless communication device 120 may represent the wireless communication device #2, and the rest may be deduced by analogy. For example, the wireless communication device #1 such as the wireless communication device 110 may be implemented as an access point (AP) device, and another wireless communication device among multiple wireless communication devices #1, . . . and #Z, such as the wireless communication device 120, may be implemented as a non-access-point (non-AP) station (STA) device, but the present invention is not limited thereto. In another example, both of the wireless communication devices #1 and #2 such as the wireless communication devices 110 and 120 may be implemented as AP devices. In yet another example, both of the wireless communication devices #1 and #2 such as the wireless communication devices 110 and 120 may be implemented as non-AP STA devices.

As shown in FIG. 1, the wireless communication device 110 may comprise a processor 112, a transceiver 114, and at least one antenna (e.g., one or more antennas), and the wireless communication device 120 may comprise a processor 122, a transceiver 124, and at least one antenna (e.g., one or more antennas). In the architecture shown in FIG. 1, the processor 112 can be arranged to control operations of the wireless communication device 110, and transceiver 114 can be arranged to perform communication operations, and more particularly, perform wireless communication operations with the wireless communication device 120 for the wireless communication device 110. In addition, the processor 122 can be arranged to control operations of the wireless communication device 120, and the transceiver 124 can be arranged to perform communication operations, and more particularly, perform wireless communication operations with the wireless communication device 110 for the wireless communication device 120.

According to some embodiments, for the case in which the wireless communication device #z such as the wireless communication device 110 (or the wireless communication device 120) is implemented as the AP device, examples of the wireless communication device #z may include, but are not limited to: a Wi-Fi router. In addition, for the case in which wireless communication device #z such as the wireless communication device 110 (or the wireless communication device 120) is implemented as the non-AP STA device, examples of the wireless communication device #z may include, but are not limited to: a multifunctional mobile phone, a laptop computer, an all-in-one computer and a wearable device.

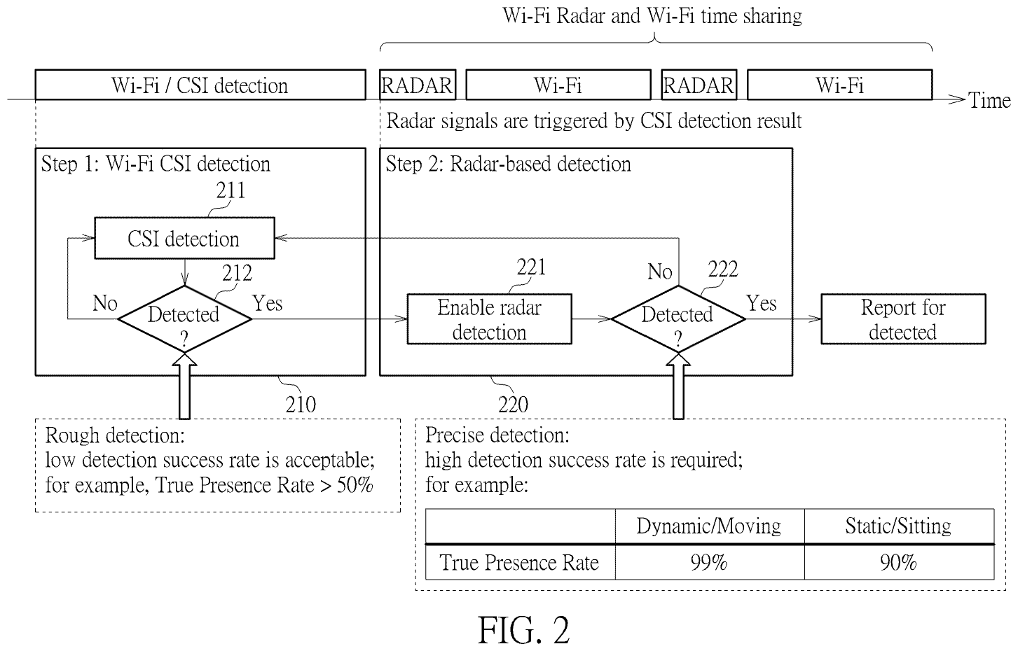

FIG. 2 illustrates a two-stage detection control scheme of a method for performing object detection with aid of multi-stage detection control in a wireless communication system (e.g., the wireless communication system 100 shown in FIG. 1) according to an embodiment of the present invention. The wireless communication system 100 (or the wireless communication device #z therein such as the wireless communication device 110 or the wireless communication device 120) may operate according to the two-stage detection control scheme for performing a CSI-based detection using raw data (e.g., I/Q raw data or I/Q signals) coming from existing Wi-Fi packets that acts as a rough detection in a first stage 210 (labeled “Step 1: Wi-Fi CSI detection” for brevity) and performing a radar-based detection that acts as a precise detection in a second stage 220 (labeled “Step 2: Radar-based detection” for brevity), in order to achieve a better overall performance, and the associated operations may comprise:
(1) in the first stage 210, the wireless communication device #z (e.g., the wireless communication device 110) may receive at least two packets such as at least two Wi-Fi packets from another wireless communication device #z′ (e.g., the wireless communication device 120) in the wireless communication system 100 and obtain at least two CSIs based on the aforementioned at least two packets, and perform a preliminary detection such as the CSI-based detection (or “the CSI detection” for brevity) according to the aforementioned at least two CSIs in Step 211 to generate a preliminary detection result which at least indicates whether a potential object is detected in Step 212, for example, if the preliminary detection result is positive/Yes indicating that the potential object is detected, Step 221 is entered, otherwise, in a situation where the preliminary detection result is negative/No indicating that no potential object is detected, Step 211 is re-entered, wherein the object may comprise a person; and
(2) in the second stage 220, in response to the preliminary detection result indicating that the potential object is detected, the wireless communication device #z (e.g., the wireless communication device 110) may enable the radar-based detection (or “the radar detection” for brevity) in Step 221, and more particularly, transmit a radar signal which may be implemented as a frequency modulated continuous wave (FMCW), receive a reflected radar signal of the radar signal, and perform the radar-based detection according to the radar signal and the reflected radar signal in Step 221 to generate a radar-based detection result which at least indicates whether the potential object is present in Step 222, for example, if the radar-based detection result is positive/Yes indicating that the potential object is present, the wireless communication device #z may report for the detected object (labeled “Report for detected” for brevity), otherwise, in a situation where the radar-based detection result is negative/No indicating that the potential object is not present, Step 211 is re-entered;

where the radar signal may be only transmitted once or twice, but the present invention is not limited thereto. For example, the radar signal may be transmitted periodically multiple times, and more particularly, may be only transmitted periodically a few times, without the need of sending the radar signal periodically all the time. For better comprehension, the aforementioned at least two Wi-Fi packets transmitted by the another wireless communication device #z′ and used for the CSI-based detection in the first stage 210 may be received in the time corresponding to the first stage 210 along the time axis (labeled “Wi-Fi/CSI detection” for brevity), the radar signal transmitted at least twice and/or only transmitted periodically a few times may be illustrated as two radar signals (labeled “RADAR” in the uppermost part of FIG. 2 for brevity), and one or more other Wi-Fi packets (e.g., any Wi-Fi packet transmitted by the wireless communication device #z or any Wi-Fi packet transmitted by the another wireless communication device #z′ or by any other device and received by the wireless communication device #z) may be illustrated as occupying most of the remaining time among the time corresponding to the second stage 220 along the time axis (labeled “Wi-Fi” for brevity), but the present invention is not limited thereto. Typically, the radar signals are triggered by the CSI detection result from the first stage 210. In addition, a Wi-Fi radar operation (or “the Wi-Fi radar”) such as the transmission/reception (TX/RX) of the radar and the reflected radar signals may use the same or similar hardware circuit(s) as that of normal Wi-Fi operations such as the TX/RX of Wi-Fi packets in the wireless communication device #z, and the Wi-Fi radar operation and one or more normal Wi-Fi operations such as the TX/RX of the one or more other Wi-Fi packets may share at least one period of time starting from the beginning time point of the second stage 220 along the time axis in a time division manner (labeled “Wi-Fi Radar and Wi-Fi time sharing” for brevity).

The respective operations of the first stage 210 and the second stage 220, as well as the action (e.g., the operation of reporting for the detected object) that is performed in response to their positive detection results, may be regarded as a multi-stage presence detection operation. Based on the two-stage detection control scheme, the wireless communication device #z (e.g., the wireless communication device 110) can increase the true presence rate (or “the hit rate”) of the potential object, in particular, up to 99% for the dynamic objects (e.g., a person who is moving) or up to 90% for the static objects (e.g., a person who is sitting), without significantly increasing the total power consumption. For example, merely performing the radar-based detection without performing the preliminary detection in advance may need to send the radar signal periodically all the time, and therefore may lead to high power consumption. With the aid of the multi-stage detection control such as the two-stage detection control of the first and the second stages 210 and 220, the wireless communication device #z can perform the preliminary detection such as the CSI-based detection in advance for achieving a rough detection result while saving power by preventing radar transmission in the first stage 210, and perform the radar-based detection for achieving a precise detection result in the second stage 220, in order to enhance the overall performance. As discussed above, the method and the associated apparatus such as the wireless communication device #z (e.g., the wireless communication device 110) can solve the related art problems without introducing any side effect or in a way that is less likely to introduce a side effect.

Some implementation details regarding object presence detection in the two-stage detection control scheme may be further described as follows.

In the first stage 210, the wireless communication device #z (e.g., the wireless communication device 110) can perform the preliminary detection such as the CSI-based detection to avoid periodic FMCW radar operation such as the operation of periodically transmitting the FMCW radar signal. The raw data for the CSI-based detection may come from existing Wi-Fi packets, such as beacons and unicast packets, and no extra TX/RX is required. The wireless communication device #z can receive the aforementioned at least two packets such as a plurality of packets carrying respective raw data for the CSI-based detection thereof to obtain at least two CSIs such as a plurality of CSIs corresponding to the plurality of packets. In addition, the wireless communication device #z can process with the CSI-based presence detection algorithm or CSI-based motion detection algorithm of the CSI-based detection to decide when to trigger the Wi-Fi radar for the radar-based detection. As the plurality of CSIs (or “the CSIs” for brevity) obtained based on the plurality of packets are varied, it can be determined that whether a potential object is detected between the wireless communication device #z and another wireless communication device #z′ based on the plurality of CSIs. In some embodiments, if presence of a potential object is detected by using the CSI-based presence detection algorithm, then it can be determined to trigger the Wi-Fi radar operation. If presence of a potential object is not detected by using the CSI-based presence detection algorithm, the wireless communication device #z may be arranged to continue to execute the steps of obtaining the CSIs and processing with the CSI-based presence detection algorithm to decide when to trigger the Wi-Fi radar. In some embodiments, if moving of a potential object is detected by using a CSI-based motion detection algorithm, then it can be determined to trigger the Wi-Fi radar operation. If moving of the potential object is not detected by using a CSI-based motion detection algorithm, the wireless communication device #z may be arranged to continue to execute the steps of obtaining the CSIs and processing with the CSI-based motion detection algorithm to decide when to trigger the Wi-Fi radar.

By using the CSI-based presence detection algorithm, moving objects and dynamic/static peoples may be detected.

As shown in the bottommost part of FIG. 2, a low detection success rate is acceptable in the rough detection while a high detection success rate is obtained in the precise detection. The wireless communication device #z (e.g., the wireless communication device 110) may use simple algorithms, such as one algorithm that can detect objects with a 20% false detection rate, to determine whether a potential object exists or whether there is a moving potential object, where the false detection may comprise mistakenly identifying the presence of the potential object when there is no the potential project, or alternatively, the false detection may comprise mistakenly identifying there is a potential moving object when there is no a potential moving object.

In the second stage 220, the wireless communication device #z (e.g., the wireless communication device 110) can perform the radar-based detection such as the FMCW-radar-based detection (or “the FMCW radar detection”) to improve the Wi-Fi CSI detection accuracy, where the wireless communication device #z sends out the radar signals and receives the reflected radar signals for presence detection. More particularly, the wireless communication device #z can process with the radar presence detection algorithm of the radar-based detection to confirm presence of the potential object. If presence of the potential object is confirmed, then it can be determined to send the detection report to the upper layer. If presence of the potential object is not confirmed, the wireless communication device #z may be arranged to continue to execute the steps of obtaining the CSIs and processing with the CSI-based presence detection algorithm or the CSI-based motion detection algorithm to decide when to trigger the Wi-Fi radar. For example, the true presence rate may be greater than 50% in the rough detection, and may reach 99% in the precise detection for the case of the dynamic objects such as the person who is moving (labeled “Dynamic/Moving” for brevity) and may reach 90% in the precise detection for the case of the static objects such as the person who is sitting (labeled “Static/Sitting” for brevity).

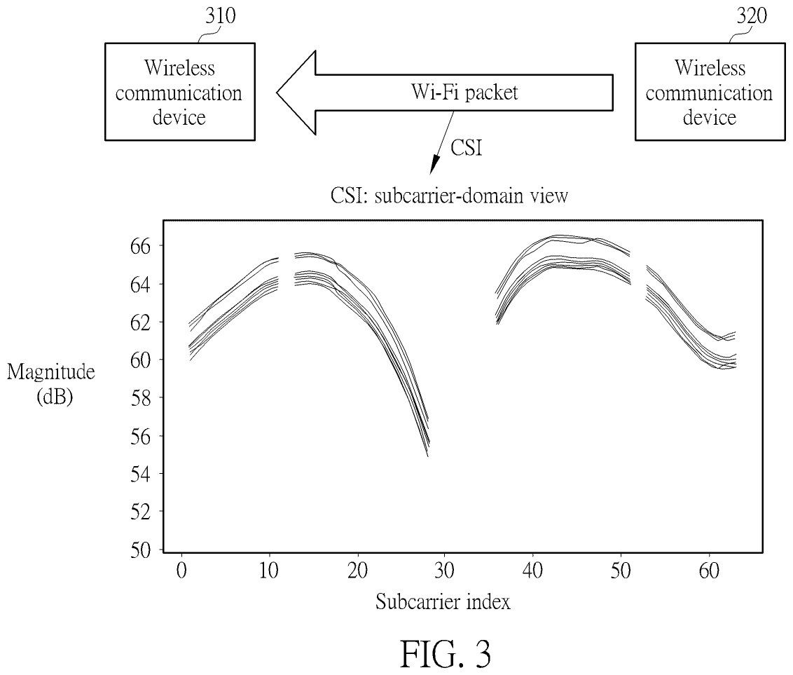

FIG. 3 illustrates a CSI-based detection control scheme of the method according to an embodiment of the present invention. A wireless communication device 310 may determine the plurality of CSIs according to the plurality of packets such as the Wi-Fi packets transmitted from a wireless communication device 320, in particular, according to the raw data (e.g., the I/Q raw data) of the plurality of packets, where the aforementioned the plurality of packets may comprise one or a combination of at least one beacon (e.g., one or more beacons) and at least one unicast packet (e.g., one or more unicast packets). For example, the plurality of CSIs may be illustrated with the curves in the subcarrier-domain view of the CSI (labeled “CSI: subcarrier-domain view” for brevity) as shown in the lower half part of FIG. 3, where the horizontal axis may represent the subcarrier index, and the vertical axis may represent the magnitude in units of decibels (dB), but the present invention is not limited thereto. According to some embodiments, the curves, the range of the subcarrier index and/or the range of magnitude may vary. Additionally, the CSI may be arranged to describe how the signal will be transmitted from the transmitter such as the wireless communication device 320 to the receiver such as the wireless communication device 310. For brevity, similar descriptions for this embodiment are not repeated in detail here.

According to some embodiments, the received signal y at the wireless communication device 310 may be expressed with the following equation:

y=Hx+n;

where “H” may represent a complex matrix, “x” may represent the transmitted signal at the wireless communication device 320, and “n” may represent the noise. Assuming that the wireless communication device 310 comprises J antennas and the wireless communication device 320 comprises K antennas, the transmitted signal x may comprise K sub-signals such as the signals {x₁, . . . , x_{K}}, the complex matrix H may comprise (J*K) elements {h} such as the elements {{h_{1,1}, . . . , h_{1,K}}, . . . , {h_{J,1}, . . . , h_{J,K}}}, the noise n may comprise J noise components such as the noise components {n₁, . . . , n_{J}}, and the received signal y may comprise J sub-signals such as the signals {y₁, . . . , y_{J}}, and therefore the complex matrix H and the associated vectors in this equation may be expressed as follows:

$$y = [ \begin{matrix}{y}_{1} \\ ⋮ \\ {y}_{J}\end{matrix} ] , H = [ \begin{matrix}{h}_{1 , 1} & … & {h}_{1 , K} \\ ⋮ & ⋱ & ⋮ \\ {h}_{J , 1} & … & {h}_{J , K}\end{matrix} ] , x = [ \begin{matrix}{x}_{1} \\ ⋮ \\ {x}_{K}\end{matrix} ] , n = [ \begin{matrix}{n}_{1} \\ ⋮ \\ {n}_{J}\end{matrix} ] .$$

For example, the CSI may be expressed with an J×K matrix having complex values as the elements thereof, such as the complex matrix H in the equation, and the wireless communication device 310 may perform channel estimation according to the long training field (LTF) in the PHY preamble of the received signal y to generate the CSI matrix for indicating the channel state, where the real part and the imaginary part of any complex value among the complex values may be arranged to describe the amplitude variance and the phase variance, respectively, but the present invention is not limited thereto. For brevity, similar descriptions for these embodiments are not repeated in detail here.

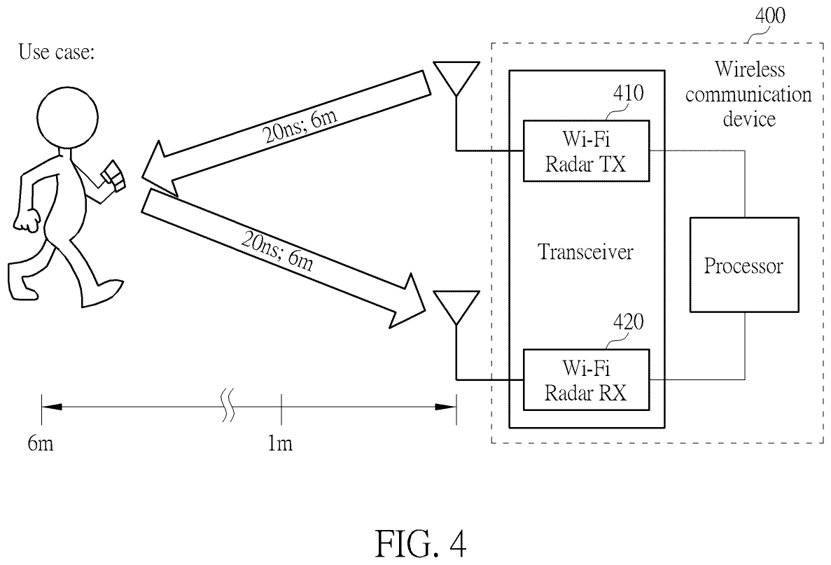

FIG. 4 illustrates a radar-based detection control scheme of the method according to an embodiment of the present invention. The wireless communication device 400 may be taken as an example of the wireless communication device #z, and the Wi-Fi radar TX circuit 410 and the Wi-Fi radar RX circuit 420 may be taken as examples of the Wi-Fi radar TX hardware circuit and the Wi-Fi radar RX hardware circuit within the aforementioned same or similar hardware circuit(s), respectively. During performing the radar-based detection according to the radar signal and the reflected radar signal to generate the radar-based detection result, the wireless communication device 400 may determine a frequency difference between the radar signal and the reflected radar signal, and determine a distance between the object and the wireless communication device 400 according to the frequency difference. More particularly, during determining the distance between the object and the wireless communication device 400 according to the frequency difference, the wireless communication device 400 may determine a time difference between the radar signal and the reflected radar signal at least according to the frequency difference, and determine the distance between the object and the wireless communication device 400 according to the time difference.

Regarding the use case shown in FIG. 4, the wireless communication device 400 can detect the distance of the object (e.g., the person who is moving or walking), such as the distance between the object and the wireless communication device 400, by using a simple FMCW tone-generation/correlation. In addition, the wireless communication device 400 can reuse some hardware of Wi-Fi (e.g. a digital-to-analog converter (DAC), Wi-Fi TX radio frequency (RF) module, an analog-to-digital converter (ADC) and a Wi-Fi RX RF module) to transmit the radar signal such as the FMCW radar signal (or the FMCW thereof) to detect the distance of object. A radar digital baseband (DBB) processing circuit within the Wi-Fi radar TX circuit 410 generates a digital radar signal, and a digital-to-analog converter (DAC) within the Wi-Fi radar TX circuit 410 converts the digital radar signal into an analog radar signal. A Wi-Fi TX radio frequency (RF) module within the Wi-Fi radar TX circuit 410 processes the analog radar signal and transmit the processed radar signal as the radar signal from the wireless communication device 400 to the object. The wireless communication device 400 can send the radar signal (or the FMCW) on the 5 GHz (5G) or 6 GHZ (6G) frequency band. For example, the bandwidth of the radar signal (or the FMCW) can be 80 megahertz (MHz), 160 MHz or 320 MHz. Taking the case of the object such as the person who is moving at the distance of 6 meters (m) as an example, in a situation the speed of light (or electromagnetic radiation) is approximately equal to (3*10⁸) meters per second (m/s), the propagation of any signal among the radar signal from the wireless communication device 400 to the object such as the person and the reflected radar signal from the object such as the person to the wireless communication device 400 may take 20 nanoseconds (ns) approximately. A Wi-Fi RX RF module within the Wi-Fi radar RX circuit 420 may process the reflected radar signal from the object to the wireless communication device 400 to generate an analog reflected radar signal. An analog-to-digital converter (ADC) within the Wi-Fi radar RX circuit 420 may convert the analog reflected radar signal into a digital reflected radar signal, and a radar DBB processing circuit within the Wi-Fi radar RX circuit 420 may compare the digital reflected radar signal with the digital radar signal generated by the DBB processing circuit within the Wi-Fi radar TX circuit 410 to generate the frequency difference, which is used by the processor 112/122.

The wireless communication device 400 may be arranged to do a de-correlation/decorrelation for the respective waveforms of the transmitted FMCW (or “the TX FMCW”) of the radar signal and the received reflection FMCW (or “the RX reflection FMCW) of the reflected radar signal in order to detect the frequency difference between the radar signal and the reflected radar signal, such as the frequency difference between the TX FMCW and the RX reflection FMCW waveforms, where the aforementioned time difference such as the time difference between the TX FMCW and the RX reflection FMCW waveforms may be calculated based on the detected frequency difference, in particular, according to the frequency difference and at least one parameter (e.g., one or more parameters) among multiple parameters of the FMCW, and the object distance (i.e., the distance of the object) may be calculated based on the time difference and the light speed (i.e., the speed of light). For example, the wireless communication device 400 may send two FMCWs FMCW(1) and FMCW(2), and determine if the calculated two distances to the object that are calculated from the two FMCWs FMCW(1) and FMCW(2) are different, for determining whether the object is moving. If the two distances are different, the wireless communication device 400 may determine that the object is moving; otherwise, the wireless communication device 400 may determine that the object is not moving. In some examples, the wireless communication device 400 may transmit multiple FMCW waveforms such as the waveforms of multiple TX FMCWs {FMCW(i)|i=1, 2, . . . } of multiple radar signals and receive multiple reflection FMCW waveforms such as the waveforms of multiple RX reflection FMCWs {FMCW′(i)|i=1, 2, . . . } of the respective reflected radar signals of the multiple radar signals, in order to get Doppler frequencies according to the multiple FMCW waveforms and the multiple reflection FMCW waveforms, and more particularly, determine the object's speed, for performing presence detection and further performing human-activity recognition (or human-activity-recognition). For brevity, similar descriptions for this embodiment are not repeated in detail here.

According to some embodiments, the multiple radar signals involved with the radar-based detection control scheme may comprise at least two radar signals such as a first radar signal and a second radar signal, and the respective reflected radar signals of the multiple radar signals may comprise at least two reflected radar signals such as a first reflected radar signal of the first radar signal and a second reflected radar signal of the second radar signal. The wireless communication device 400 may transmit the aforementioned at least two radar signals, and receive the aforementioned at least two reflected radar signals, where the aforementioned at least two radar signals comprise the first radar signal and the second radar signal, and the aforementioned at least two reflected radar signals comprise the first reflected radar signal and the second reflected radar signal. Taking the multiple TX FMCWs {FMCW(i)|i=1, 2, . . . } and the multiple RX reflection FMCWs {FMCW′(i)|i=1, 2, . . . } as examples of the multiple radar signals and the reflected radar signals thereof, respectively, when the first radar signal and the second radar signal are implemented as the TX FMCWs {FMCW(1), FMCW(2)}, the radar signal from the wireless communication device 400 to the object such as the person may represent any radar signal among the first radar signal and the second radar signal, such as any TX FMCW FMCW(i) among the TX FMCWs {FMCW(1), FMCW(2)}, and the reflected radar signal from the object such as the person to the wireless communication device 400 may represent a corresponding reflected radar signal of the aforementioned any radar signal among the first reflected radar signal and the second reflected radar signal, such as a corresponding RX reflection FMCW FMCW′(i) of the aforementioned any TX FMCW FMCW(i) among the RX reflection FMCWs {FMCW′(1), FMCW′(2)}.

The aforementioned frequency difference between the radar signal and the reflected radar signal may represent any frequency difference f_{b}(i) among a first frequency difference f_{b}(1) between the first radar signal and the first reflected radar signal and a second frequency difference f_{b}(2) between the second radar signal and the second reflected radar signal, such as any frequency difference f_{b}(i) among the first frequency difference f_{b}(1) between the TX FMCW FMCW(1) and the RX reflection FMCW FMCW′(1) and the second frequency difference f_{b}(2) between the TX FMCW FMCW(2) and the RX reflection FMCW FMCW′(2). In addition, the aforementioned distance between the object and the wireless communication device 400 may represent any distance among a first distance between the object and the wireless communication device 400 and a second distance between the object and the wireless communication device 400, where the first distance is determined according to the first frequency difference f_{b}(1), and the second distance is determined according to the second frequency difference f_{b}(2). Moreover, the radar-based detection result may further indicate whether the object is moving. During performing the radar-based detection according to the radar signal such as the TX FMCW FMCW(i) and the reflected radar signal such as the RX reflection FMCW FMCW′(i) to generate the radar-based detection result, the wireless communication device 400 may determine whether the object is moving according to the first distance and the second distance, for generating the radar-based detection result. For brevity, similar descriptions for these embodiments are not repeated in detail here.

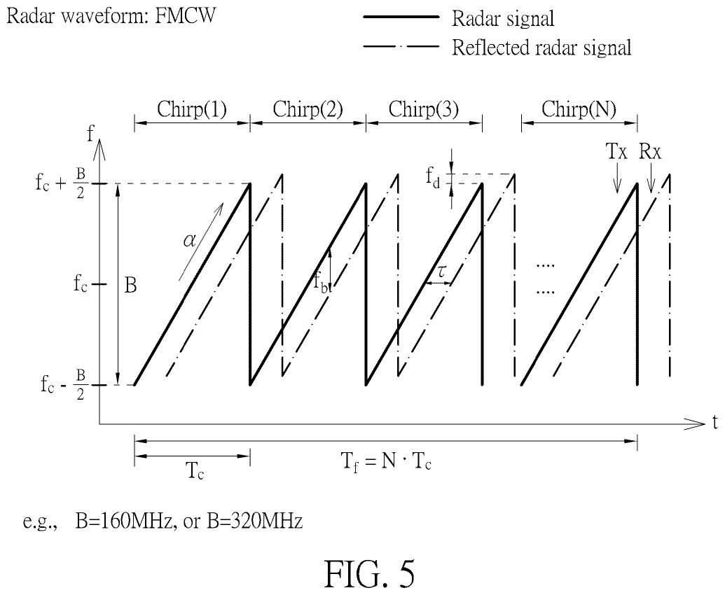

FIG. 5 illustrates some implementation details of the radar-based detection control scheme shown in FIG. 4 according to an embodiment of the present invention, where the radar signal and the reflected radar signal may be illustrated as FMCWs with respect to the time axis t and the frequency axis f. Regarding the multiple parameters of the FMCW, such as the parameters {B, f_{c}, α, T_{c}, T_{f}, N}, “B” may represent the bandwidth of the radar waveform (or the FMCW) of the radar signal, “f_{c}” may represent the center frequency of the bandwidth B, “α” may represent the frequency variation rate such as the variation of the frequency f per unit time, “T_{c}” may represent the time period per chirp such as the time period of any chirp among the N chirps {Chirp(1), Chirp(2), Chirp(3), . . . , Chirp(N)}, “Tr” may represent the total time period of the N chirps {Chirp(1), Chirp(2), Chirp(3), . . . , Chirp(N)}, and “N” may represent the chirp count of the N chirps {Chirp(1), Chirp(2), Chirp(3), . . . , Chirp(N)}. In addition, the reflected radar signal of the radar signal may be similar to the transmitted radar signal but with some delay. As shown in FIG. 5, “f_{b}” may represent the frequency difference between the TX FMCW and the RX reflection FMCW waveforms (respectively labeled “Tx” and “Rx” for brevity), “t” may represent the time difference between the TX FMCW and the RX reflection FMCW waveforms, and “fa” may represent the Doppler frequency. The wireless communication device 400 may calculate the time difference t between the TX FMCW and the RX reflection FMCW waveforms according to the frequency difference f_{b} and the aforementioned at least one parameter such as the parameters B, f_{c}, α, T_{c}, T_{f} and/or N. For example, the bandwidth B may be equal to 160 MHz or 320 MHz, but the present invention is not limited thereto. In some examples, the bandwidth B may vary, and more particularly, may be equal to one of some other values. For brevity, similar descriptions for this embodiment are not repeated in detail here.

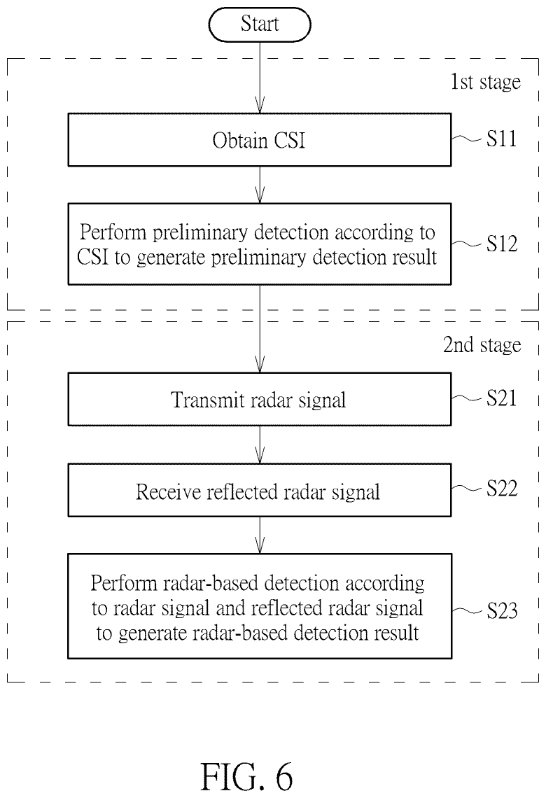

FIG. 6 illustrates a working flow of the method according to an embodiment of the present invention, where the wireless communication device #z may execute Steps S11 and S12 in the first stage (labeled “the 1st stage” for brevity) such as the first stage 210 shown in FIG. 2, and may execute Steps S21 to S23 in the second stage (labeled “the 2nd stage” for brevity) such as the second stage 220 shown in FIG. 2.

In Step S11, the wireless communication device #z may receive the aforementioned at least two packets such as the aforementioned at least two Wi-Fi packets from another wireless communication device such as the wireless communication device #z′ in the wireless communication system 100 to obtain the aforementioned at least two CSIs corresponding to the aforementioned at least two packets.

In Step S12, the wireless communication device #z may perform the preliminary detection such as the CSI-based detection according to the aforementioned at least two CSIs to generate the preliminary detection result, where the preliminary detection result may at least indicate whether a potential object is detected between the wireless communication device and the another wireless communication device.

In Step S21, in response to the preliminary detection result indicating that the potential object is detected, the wireless communication device #z (e.g., the wireless communication device 400 shown in FIG. 4, for the operations of the 2nd stage such as the second stage 220 shown in FIG. 2) may transmit the radar signal which may be implemented as the FMCW radar signal.

In Step S22, the wireless communication device #z (e.g., the wireless communication device 400 shown in FIG. 4) may receive the reflected radar signal of the radar signal.

In Step S23, the wireless communication device #z (e.g., the wireless communication device 400 shown in FIG. 4) may perform the radar-based detection according to the radar signal and the reflected radar signal to generate the radar-based detection result, where the radar-based detection result may at least indicate whether the potential object is present.

For better comprehension, the method may be illustrated with the working flow shown in FIG. 6, but the present invention is not limited thereto. According to some embodiments, one or more steps may be added, deleted, or changed in the working flow shown in FIG. 6. For example, Steps S21 to S23 may be executed multiple times for detecting whether a potential object is present. In addition, after the operations of the second stage is completed, the wireless communication device #z may enter the first stage again in order to perform the multi-stage presence detection operation (the operations of Steps S11 and S12 in the first stage as well as the operations of Steps S21 to S23 in the second stage) for the next round. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing object detection with aid of multi-stage detection control in a wireless communication system, performed by a first wireless communication device, the method comprising:
receiving at least two packets from a second wireless communication device, obtaining at least two channel state information (CSI) based on the at least two packets, and performing a preliminary detection according to the at least two CSIs to generate a preliminary detection result in a first stage, wherein the preliminary detection result at least indicates whether a potential object is detected between the first wireless communication device and the second wireless communication device; and
in response to the preliminary detection result indicating that the potential object is detected, transmitting a radar signal, receiving a reflected radar signal of the radar signal, and performing a radar-based detection according to the radar signal and the reflected radar signal to generate a radar-based detection result in a second stage after the first stage, wherein the radar-based detection result at least indicates whether the potential object is present.

2. The method of claim 1, wherein the step of performing the preliminary detection according to the at least two CSIs to generate the preliminary detection result comprises:
performing the preliminary detection according to the at least two CSIs to determine whether there is a potential moving object between the first wireless communication device and the second wireless communication device, and if there is the potential moving object between the first wireless communication device and the second wireless communication device, the preliminary detection result indicates that the potential object is detected.

3. The method of claim 1, wherein the step of performing the preliminary detection according to the at least two CSIs to generate the preliminary detection result comprises:
performing a CSI-based presence detection algorithm according to the at least two CSIs to determine whether the potential object is present, and if the potential object is present, the preliminary detection result indicates that the potential object is detected.

4. The method of claim 1, wherein the radar signal is transmitted periodically multiple times in the second stage, without need of sending the radar signal periodically all time.

5. The method of claim 1, wherein the radar signal is only transmitted once or twice in the second stage.

6. The method of claim 1, wherein performing the radar-based detection according to the radar signal and the reflected radar signal to generate the radar-based detection result further comprises:
determining a frequency difference between the radar signal and the reflected radar signal; and
determining a distance between the potential object and the first wireless communication device according to the frequency difference.

7. The method of claim 6, wherein determining the distance between the potential object and the first wireless communication device according to the frequency difference further comprises:
determining a time difference between the radar signal and the reflected radar signal at least according to the frequency difference; and
determining the distance between the potential object and the first wireless communication device according to the time difference.

8. The method of claim 6, wherein the radar signal is a first radar signal; and the method further comprise:
transmitting a second radar signal;
receiving a reflected radar signal of the second radar signal;
determining a second frequency difference between the second radar signal and the reflected radar signal of the second radar signal; and
determining a second distance between the potential object and the first wireless communication device according to the second frequency difference.

9. The method of claim 8, further comprising:
determining whether the potential object is moving according to the first distance and the second distance.

10. The method of claim 8, wherein in the second stage, transmission and reception of a Wi-Fi signal and transmissions of a plurality of radar signals comprising the first radar signal and the second radar signal are performed by the first wireless communication device in a time division manner.

11. The method of claim 1, wherein the radar signal is a frequency modulated continuous wave (FMCW).

12. A wireless communication device, for performing object detection with aid of multi-stage detection control in a wireless communication system, the wireless communication device comprising:
a transceiver, configured to receive at least two packets from a second wireless communication device; and
a processor, coupled to the transceiver, configured to control operations of the wireless communication device;
wherein:
the processor is further configured to obtain at least two channel state information (CSI) based on the at least two packets, and perform a preliminary detection according to the at least two CSIs to generate a preliminary detection result in a first stage, wherein the preliminary detection result at least indicates whether a potential object is detected between the wireless communication device and the second wireless communication device;
the transceiver is further configured to transmit a radar signal in response to the preliminary detection result indicating that the potential object is detected, and receive a reflected radar signal of the radar signal; and
the processor is further configured to perform a radar-based detection according to the radar signal and the reflected radar signal to generate a radar-based detection result in a second stage after the first stage, wherein the radar-based detection result at least indicates whether the potential object is present.

13. The wireless communication device of claim 12, during performing the preliminary detection according to the at least two CSIs to generate the preliminary detection result, the wireless communication device is configured to perform the preliminary detection according to the at least two CSIs to determine whether there is a potential moving object between the wireless communication device and the second wireless communication device, and if there is the potential moving object between the wireless communication device and the second wireless communication device, the preliminary detection result indicates that the potential object is detected.

14. The wireless communication device of claim 12, during performing the preliminary detection according to the at least two CSIs to generate the preliminary detection result, the wireless communication device is configured to perform a CSI-based presence detection algorithm according to the at least two CSIs to determine whether the potential object is present, and if the potential object is present, the preliminary detection result indicates that the potential object is detected.

15. The wireless communication device of claim 12, wherein the radar signal is transmitted periodically multiple times in the second stage, without need of sending the radar signal periodically all time.

16. The wireless communication device of claim 12, wherein the radar signal is only transmitted once or twice in the second stage.

17. The wireless communication device of claim 12, wherein during performing the radar-based detection according to the radar signal and the reflected radar signal to generate the radar-based detection result, the processor is arranged to determine a distance between the potential object and the wireless communication device according to a frequency difference between the radar signal and the reflected radar signal.

18. The wireless communication device of claim 17, wherein the radar signal is a first radar signal; the transceiver is further configured to transmit a second radar signal, and receive a reflected radar signal of the second radar signal; and the processor is configured to determine a second distance between the potential object and the wireless communication device according to a second frequency difference between the second radar signal and the reflected radar signal of the second radar signal.

19. The wireless communication device of claim 18, wherein the processor is configured to determine whether the potential object is moving according to the first distance and the second distance.

20. The wireless communication device of claim 18, wherein in the second stage, transmission and reception of a Wi-Fi signal and transmissions of a plurality of radar signals comprising the first radar signal and the second radar signal are performed by the wireless communication device in a time division manner.
